(19) United States
(12) Patent Application Publication
(10) Pub. No.: US 2003/0071948 A1
(43) Pub. Date: Apr. 17, 2003

(54) Display element containing hologram and conductive layer

(76) Inventors: Thomas C. Felder, Kennett Square, PA (US); William John Gambogi JR., Wilmington, DE (US); Michael L. Levin, Newark, DE (US)

Correspondence Address: E I DU PONT DE NEMOURS AND COMPANY, LEGAL PATENT RECORDS CENTER, BARLEY MILL PLAZA 25/1128, 4417 LANCASTER PIKE, WILMINGTON, DE, 19805, US

(21) Appl. No.: 10/256,390

(22) Filed: Sep. 27, 2002

Related U.S. Application Data
(60) Provisional application No. 60/329,286, filed on Oct. 15, 2001.

(51) Int. Cl. G02F 1/1333

(52) U.S. Cl. 349/122

(57) ABSTRACT

A display element comprises a hologram, a barrier layer, and an optically transparent and electrically conductive layer. A film-based method for applying a barrier layer to a hologram without damaging the hologram from contact with solvent(s) is also disclosed.

### BACKGROUND OF THE INVENTION

1. Field of the Invention

This invention pertains to a display element comprised of a hologram, a barrier layer, and an optically transparent and electrically conductive layer.

2. Description of Related Art

Holograms and holographic optical elements (HOEs) in combination with a liquid crystal display (LCD) are known to the art. For example, U.S. Pat. No. 5,663,816 assigned to Motorola describes a reflective HOE in combination with an LCD for use in display applications. U.S. Pat. No. 5,659,408 assigned to Polaroid describes a transmissive HOE in combination with an LCD that is also used in display applications, and U.S. Pat. No. 5,930,011 to assigned DuPont describes holographic multicolor optical elements for use in liquid crystal displays. Most such combinations of holograms/HOEs with LCDs that are known to the art have separate and discrete hologram/HOE and LCD units with no portion of the hologram/HOE unit being within the LCD unit and vice versa.

In many applications, there is a need to incorporate a hologram or HOE directly within the stack structure of an LCD in order to eliminate deleterious parallax effects as well as to afford greater brightness, deeper color saturation, and optimization of viewing angle to avoid glare (in relation to that when the hologram or HOE is outside the LCD such as described in U.S. Pat. No. 5,930,011). The adverse effects of parallax are eliminated or at least minimized when there is minimal separation of active layers of the LCD and the hologram/HOE as is provided for when the hologram or HOE is located within the LCD stack. For particular display applications, there is a significant need for an HOE/LCD combination wherein the HOE is in close proximity to an optically transparent and electrically conductive layer, typically indium tin oxide (ITO) of the LCD in order to avoid or minimize parallax problems.

In order to place the conductive layer in close proximity to the hologram or HOE, which is effected typically by a vapor deposition process, it is necessary to have a suitable surface for receiving the conductive layer material, e.g., ITO, as well as to protect the hologram during processing steps of conductor deposition and other steps in LCD manufacture so that it is not damaged. Typically, in constructing an LCD having a hologram, e.g., a HOE, within the LCD stack structure, the hologram needs to survive various cleaning processes, indium tin oxide deposition, photoresist application, patterning and development, acid etching of the exposed ITO regions, stripping of the photoresist, and processing of subsequent layers such as a polyimide alignment layer. The hologram itself is not inherently capable of surviving typical LCD manufacturing conditions without a suitable intervening barrier layer separating it from the conductive layer. A suitable barrier layer though must be sufficiently thick in order to prevent all components of the processing chemical solutions used in LCD fabrication from reaching the hologram and likely damaging and/or altering it. At the same time, a suitable barrier layer must be sufficiently thin so as not to result in any significant parallax problem in optically coupling the layers of the LCD stack. These requirements for the barrier layer are working in opposite directions and yet must be simultaneously achieved to reasonable degrees, since both are important.

Prior art hologram or HOE/LCD combinations do not fully address or meet the above need for a suitable barrier layer. In an open literature publication (Implementation of Reflective Full Color LCDs with Directive Reflection, M. Yaginuma et al., ASET International Forum on Low Power Displays, Tokyo, JP, Jul. 21, 2000), a relatively thick glass layer (50 microns) was used to separate a holographic optical element from an ITO layer of an LCD. This relatively thick glass layer still creates parallax problems as well as being difficult and impractical to manufacture. There is a continuing need for improved barrier layer materials of smaller thickness, which effectively protect holograms and HOEs from aggressive processing conditions of LCD fabrication to permit their placement within LCD stacks.

### SUMMARY OF THE INVENTION

The invention is a display element comprising a hologram and an optically transparent and electrically conductive layer in which a relatively thin barrier layer is interposed between the hologram and the conductive layer. More specifically, the display element comprises:

a) an optically transparent and electrically conductive layer;

b) a hologram disposed adjacent the conductive layer; and

c) a barrier layer disposed between the conductive layer and the hologram; wherein the improvement comprises the barrier layer having a first surface in direct contact with the hologram and a second surface opposite the first surface in direct contact with the conductive layer. The barrier layer can comprise either organic polymer(s) or inorganic nitride(s), and has a thickness less than 40 microns and, preferably, less than 20 microns.

A method of making a display element containing an optically transparent and electrically conductive layer and a hologram disposed adjacent the conductive layer comprises:

a) forming a barrier layer having a first surface in direct contact with the hologram, the barrier layer having a second surface opposite the first surface and a thickness less than 40 microns; and

b) forming the conductive layer directly on the second surface.

The step of forming the barrier layer without damaging the hologram may be performed by:

a) dissolving or dispersing material of the barrier layer in at least one solvent to afford a coating liquid;

b) applying the coating liquid on a flexible substrate;

c) heating the coating liquid on the substrate at a suitable drying temperature to effect removal of substantially all of the solvent and thereby afford a dry but uncured barrier layer on the flexible substrate;

d) laminating the uncured barrier layer disposed on the flexible substrate to a hologram;

e) curing the barrier layer; and

f) removing the flexible substrate to form a laminate of the barrier layer and the hologram.

### BRIEF DESCRIPTION OF THE DRAWINGS

FIG. 1 is a diagrammatic elevation view of a display element according to the invention.

### DETAILED DESCRIPTION OF THE PREFERRED EMBODIMENT(S)

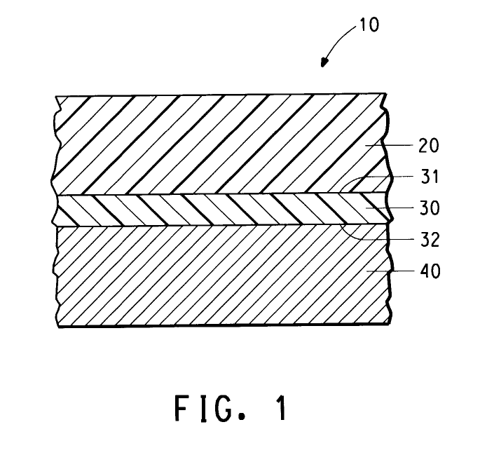

FIG. 1 shows a display element 10 comprising of a hologram layer 20, a barrier layer 30, and an optically transparent and electrically conductive layer 40. The barrier layer 30 has a first surface 31 that is in direct contact with the hologram 20 and a second surface 32, which is opposite the first surface 31, that is in direct contact with the conductive layer 40.

Barrier Layer

The barrier layer 30 can comprise, but is not limited to, an organic polymer, an inorganic nitride, or a metal nitride. The barrier layer 30 preferably comprises an organic polymer. Examples of suitable organic polymeric materials for the barrier layer 30 are the following: polyurethane, polyimide, (meth)acrylate polymer, and epoxy polymer. Examples of suitable inorganic or metal nitrides for the barrier layer 30 are the following: silicon nitride, aluminum nitride, aluminum oxynitride, or silicon oxynitride. A preferred polymeric material for the barrier layer 30 is urethane acrylate polymer.

The thickness of the barrier layer 30 is greater than 3 microns and less than 40 microns. The thickness of the barrier layer 30 preferably is less than about 30 microns, more preferably is less than about 20 microns, still more preferably is less than about 15 microns, and yet still more preferably is less than about 10 microns with the proviso for each preference that the thickness is always greater than 3 microns. If the thickness is greater than about 40 microns, the distance between the conductive layer and the hologram layer is sufficiently large such that significant adverse parallax problems come into play. If the thickness is less than about 3 microns, the barrier layer may be too thin to provide a suitable covering of the hologram layer that is suitable for deposition of the conductive layer during LCD fabrication and/or may be too thin to provide adequate protection of the hologram layer from being destroyed or altered by chemical(s) used in the processing steps for LCD fabrication (as described infra).

Hologram Layer

The hologram layer 20 can comprise a single hologram, such as a graphic arts hologram, or it can comprise multiple holograms. The hologram layer 20 can also comprise a holographic optical element. The hologram(s) or holographic optical element(s) of the hologram layer 20 can be volume or surface-relief hologram(s) or HOEs. The photosensitive material in which hologram(s) and/or HOE(s) of the hologram layer 20 are holographically recorded can be, but is not limited to, photopolymer and dichromated gelatin.

Optically Transparent and Electrically Conductive Layer

The optically transparent and electrically conductive layer can be comprised of any material that is both optically transparent and electrically conductive. Suitable materials for this layer include, but are not limited to, indium-tin-oxides (ITOs), aluminum doped zinc oxides (AZOs), aluminum doped tin oxides (ATOs), tin-oxides, and the like. These conductive coatings are made of doped metal oxide compounds which are transparent from near UV to mid-infrared regions of the electromagnetic spectrum. Indium-tin-oxides (ITOs) are preferred.

Formation of the Barrier Layer

A variety of techniques can be employed to apply the barrier layer to either the hologram or HOE layer or to the conductive layer without limitation. Examples of suitable techniques include dissolving or dispersing the barrier layer material in a solvent(s) and coating (e.g., spin coating, knife coating) it on the layer (e.g., hologram or HOE) to which it is being applied. In instances where a solvent or solvent system is known and available that does not degrade, swell, or otherwise adversely alter the layer to which it is being applied, these techniques are very suitable.

In other instances, many common solvent(s) used for dissolving or dispersing barrier layer materials are known to adversely degrade holograms or HOEs. In these cases, the alternate technique of applying a film-based protective coating as described below is useful and is preferred. Barrier layer materials dissolved or dispersed in solvents that could damage a hologram or HOE are coated on to a flexible substrate and then dried at temperatures that do not cause curing of the coating to afford a barrier layer film.

The barrier layer film, if not used immediately, can optionally then be covered with a protective sheet such as siliconized polyester, siliconized paper, wax paper, or other releasable material. To apply the barrier layer film to a hologram or HOE (or other layer to which it is to be applied), the optional protective cover is removed, and the film on the flexible substrate is then laminated to the hologram or HOE. The resulting barrier layer film/hologram or HOE laminate is then cured either by exposure to ultraviolet or other actinic radiation and/or by heating at an elevated temperature. The flexible substrate is then removed, leaving the hologram or HOE in contact with the cured barrier layer film. The coating can also be radiation-cured using ultraviolet of other suitable wavelengths.

In this invention, choice of specific process conditions (e.g., drying temperature, lamination temperature, curing temperature) depend upon choice of coating solvent, barrier material, and barrier layer thickness as well as other parameters. In many instances though, drying temperatures ranging from about 50° to about 90° C. can be used for effecting drying (bulk solvent removal) without any significant curing of photopolymers in this invention, depending upon the choice of solvent(s). In many instances, lamination temperatures ranging typically from about 60° to about 90° C. can be used for effecting lamination of the uncured barrier layer on the flexible substrate to the hologram. Furthermore, in many instances, curing temperatures ranging from about 90° to about 160° C., typically 100° C.-140° C., can be used for effecting at least substantial curing of the barrier layer subsequent to its lamination on the hologram.

Film lamination processes (such as described supra) are advantageous in that they can be engineered relatively inexpensively for very high production output (e.g., thousands of square feet per hour).

### Glossary

UV “A” radiation—UV “A” radiation is defined to be ultraviolet light of wavelength 315-400 nm in Light Measurement Handbook, by Alex Ryer, International Light, Inc., Newburyport, Mass. (1997).

### EXAMPLES

### Example 1

A photopolymer holographic recording film (HRF, Omnidex® 706 from E. I. du Pont de Nemours & Co., Inc., Wilmington, Del.) was imaged at 476 nm for 30 seconds with an Ar+laser in a “Denisyuk” arrangement to produce a copy of a master hologram in the holographic recording film. The hologram was given a uniform UV “A” radiation exposure at a level of 10-30 mJ/cm², then laminated to CTF146 color tuning film (E. I. du Pont de Nemours & Co., Inc., Wilmington, Del.). The resulting laminate was then heated to 150° C. for 8 minutes and allowed to cool. This produced a uniform bright green hologram.

To a 4″×5″ piece of Corning float glass, a dual liner pressure sensitive adhesive (Adhesive Research 8154, Glen Rock, Pa.) was laminated. The remaining adhesive liner was then removed. The HRF/CTF laminate sheet was cut to roughly 5″×6″, and the polyester base was removed from the CTF side. The HRF/CTF was then laminated to the pressure sensitive adhesive such that the CTF faced the glass and the HRF faced the air. The polyester base was then removed from the HRF.

The glass plate bearing the laminated hologram was then mounted on a Headway spin coater with the holographic film facing up. A waterborne UV-curable composition (F4769 Waterborne UV Clearcoat, which is urethaneacrylate polymer with photoinitiator dispersed in water, DuPont Performance Coatings, Wuppertal, Germany) was flooded onto the hologram and then the plate was started spinning at 2000 RPM for 2 minutes. The coated plate was dried at 60° C. for 5 minutes, then exposed to 1J exposure of UV “A” radiation under a nitrogen blanket.

The clearcoat formed a smooth transparent barrier coating of 5 microns thickness upon drying and had no effect on the appearance of the hologram. The barrier coating was sprayed for 10 seconds with, in succession, methanol, isopropanol, acetone, methyl ethyl ketone, ethyl acetate, hexane, toluene, and distilled water. The appearance of the hologram was unaffected, and the barrier coating remained firmly adhered with excellent appearance.

Indium-Tin Oxide (ITO) was vapor deposited onto the barrier coating with a deposition coater (Genvac Aerospace Corporation, Cleveland, Ohio) using an ion-assisted ebeam evaporative technique with the plate held at 90° C. This formed an approximately 1200 Angstrom-thick ITO coating with a resistivity of 50 ohms/square. The ITO was smooth and transparent, and showed no cracking.

The ITO coating was next patternwise etched. Photoresist (S1818 Photoresist, Shipley Co., Marlborough, Mass.) was spin coated at 1500 RPM and dried at 95° C. for 1 minute. The resist was exposed with UV “A” radiation through a lettering target. The resist was developed with MF312-CD27 developer (Shipley Co.) for 30 seconds, then baked at 110° C. for 2 minutes. The exposed ITO was etched away in a sulfuric acid/nitric acid bath for 5-10 sec at 50° C. The etched sample was washed with water. Finally the resist was stripped by spraying acetone onto the surface of the plate and then the resulting etched, stripped sample was rinsed with methanol, water, and isopropanol. The appearance of the hologram was unaffected. The ITO was cleanly etched, uncracked, and the hologram's appearance was the same in etched and unetched areas.

### Comparative Example

A photopolymer hologram with no barrier was sprayed with acetone. The holographic film dissolved and the hologram was destroyed.

A photopolymer hologram laminated to glass as above with no barrier was coated with ITO as above. The ITO was observed to be cracked and crazed with a hazy appearance.

### Example 2

Waterborne Clearcoat Solution F4976 (DuPont Performance Coatings, Wuppertal, Germany) was coated on 200D Mylar®) polyester film (E. I. du Pont de Nemours and Company, Wilmington, Del.) with a slot die coater and dried for 30-60 seconds at 60°-90° C. A silicone-treated polyester coversheet, Ultraclear 8308 (Saint-Gobain Performance Plastics, Worcester, Mass.) was laminated to the dried coating. To a hologram prepared as described in Example 1, the Clearcoat was laminated by removing the silicone-treated coversheet, then applying to film, Clearcoat down onto the hologram using motorized pinch rollers heated to 50°-80° C., which transported the film laminate at 1-5 ft/min. The clearcoat was cured by irradiating though the Mylar® base with 0.5 J/cm2 of UV “A” radiation, then the Mylar® base was removed. The resulting coating was found to be resistant to sprayed acetone. ITO was deposited on the clearcoat, and a reflective LCD was assembled (as detailed infra) using the ITO-coated hologram as the bottom layer.

General assembly of a passively-addressed liquid crystal display (LCD), such as the reflective LCD described in this example, requires forming patterned indium-tin oxide (ITO) on a rigorously flat surface, typically glass. The reflective LCD was assembled by vacuum-depositing a uniform layer of ITO onto a hologram-bearing glass substrate, subsequently the ITO film was coated with photoresist (S1818, from Shipley Company, LLC, Marlborough, Mass.), and then the dried resist was exposed with UV radiation though a photomask to form the desired patterning. The resist pattern was developed by washing with developer solution (Shipley MF312-CD27), rinsed and then baked at 110° C. for 2 minutes to toughen the resist pattern protecting the ITO. The substrate was then treated with acid, which was a mixture of hydrochloric and nitric acid at 20° C. for 45 seconds, at which point unprotected ITO was dissolved. The substrate was then rinsed, and the hardened resist was removed with acetone. A barrier film solution was then spin-coated onto the patterned ITO (AT-720A from Nissan Chemical Industries, Ltd., Tokyo, Japan). The film was dried and cured by 1 hour exposure with a 10 mW/cm2 UV light in an Electro-Lite exposure frame, followed by baking 1 hour at 120° C. Next, an alignment film, which was a polyimide solution, RN-1155 (from Nissan Chemical Industries) was spin-coated onto the substrate, which was subsequently dried and baked at 120° C. for 90 minutes. The alignment layer was then rubbed with a Fine Puff brand cloth from Yoshikawa Chemical Co. (Osaka, Japan) manually 15 times to induce alignment of the liquid crystal director in the rub direction. A second substrate was similarly prepared, except that the substrate bore no hologram and the ITO was not patterned. Onto the hologram-bearing substrate, fine polymer spacer beads (3.7 micron Sekisui MicroPearl®, Sekisui Chemical Co., Ltd., Tokyo, Japan) were sprayed forming a uniform coating. The bead-coated substrate was pressed against the freshly-rubbed substrate such that alignment films from each substrate faced one another. Gasket seal (Norland 68 Optical Adhesive, Norland Products, Inc., Cranbury, N.J.) was then dispensed around the perimeter of the gap between substrates, leaving a hole for subsequent injection. A vacuum was drawn in the gap, and liquid crystal (ZLI-2244-100 with chiral component C-15 from Merck KGaA, Liquid Crystal Division, Darmstadt, Germany) was then injected into the evacuated gap while the substrates were pressed together, forming a filled layer 3.7 microns thick. The filler hole was sealed with epoxy. Polarizer (G1220 DUN) and Retarder film (achromatic quarter wave, both from Nitto Denko Corporation, Tokyo, Japan) were then laminated to the incident side of the LCD with the polarizer on top. Control circuitry was then soldered onto the ITO contact pads.

The hologram in the resulting assembled LCD was observed to be bright and uniform, having survived all processing steps well. The hologram was observed to be bright under ambient lighting with no observable change from its initial properties.

What is claimed is:

1. In a display element comprising:
a) an optically transparent and electrically conductive layer;
b) a hologram disposed adjacent the conductive layer; and
c) a barrier layer disposed between the conductive layer and the hologram;
the improvement comprising the barrier layer having a first surface in direct contact with the hologram and a second surface opposite the first surface in direct contact with the conductive layer, wherein the barrier layer has a thickness less than 40 microns.

2. The display element of claim 1 wherein the barrier layer comprises a material selected from the group consisting of polyurethane, polyimide, (meth)acrylate polymer, epoxy polymer and nitride.

3. The display element of claim 2 wherein the barrier layer comprises urethane acrylate.

4. The display element of claim 1 wherein the barrier layer has a thickness less than 20 microns.

5. The display element of claim 1 wherein the conductive layer comprises indium tin oxide.

6. The display element of claim 1 wherein the display element is a liquid crystal display.

7. A method of making a display element containing an optically transparent and electrically conductive layer and a hologram disposed adjacent the conductive layer comprising:
a) forming a barrier layer having a first surface in direct contact with the hologram, the barrier layer having a second surface opposite the first surface and a thickness less than 40 microns; and
b) forming the conductive layer directly on the second surface.

8. The method of claim 7 wherein the barrier layer comprises a material selected from the group consisting of polyurethane, polyimide, (meth)acrylate polymer, epoxy polymer and nitride.

9. The method of claim 8 wherein the barrier layer comprises urethane acrylate.

10. The method of claim 7 wherein the barrier layer has a thickness less than 20 microns.

11. The method of claim 7 wherein the conductive layer comprises indium tin oxide.

12. The method of claim 7 wherein the display element is a liquid crystal display.

13. The method of claim 7 wherein the step of forming the barrier layer comprises:
(a) dissolving or dispersing material of the barrier layer in at least one solvent to afford a coating liquid;
(b) applying the coating liquid on a flexible substrate;
(c) heating the coating liquid on the substrate at a suitable drying temperature to effect removal of substantially all of the solvent and thereby afford a dry but uncured barrier layer on the flexible substrate;
(d) laminating the uncured barrier layer disposed on the flexible substrate to a hologram;
(e) curing the barrier layer; and
(f) removing the flexible substrate to form a laminate of the barrier layer and the hologram.
